(19) United States
(12) Patent Application Publication
(10) Pub. No.: US 2022/0245310 A1
(43) Pub. Date: Aug. 4, 2022

(54) SYSTEM AND METHOD FOR MODELING RIGID BODY MOTIONS WITH CONTACTS AND COLLISIONS

(71) Applicant: Siemens Aktiengesellschaft, Munich (DE)

(72) Inventors: Yaofeng Zhong, West Windsor, NJ (US); Biswadip Dey, Plainsboro, NJ (US); Amit Chakraborty, East Windsor, NJ (US)

(21) Appl. No.: 17/591,252

(22) Filed: Feb. 2, 2022

Related U.S. Application Data
(60) Provisional application No. 63/144,495, filed on Feb. 2, 2021.
(60) Provisional application No. 63/144,492, filed on Feb. 2, 2021.

(51) Int. Cl. G06F 30/27; G06F 30/23; G06N 3/08

(52) U.S. Cl. CPC G06F 30/27; G06F 2119/14; G06N 3/084; G06F 30/23

(57) ABSTRACT

System and method for modeling motion and collision of rigid bodies in a dynamic system includes a collision detector that detects active contacts of the rigid bodies. A differentiable contact impulse solver applies constraints on contact forces related to a compression phase, applies coefficient of restitution on contact forces related to a restitution phase, solves for contact forces and velocity impulses associated with the active contacts in the compression phase and the restitution phase, and estimates trajectories of the rigid bodies while optimizing for maximum rate of energy dissipation.

### TECHNICAL FIELD

This application relates to machine learning. More particularly, this application relates to applying a machine learning framework for simulation of rigid bodies with contacts and collisions related to engineering design and manufacture of industrial components.

### BACKGROUND

A large class of real-world applications, such as designing end-effector paths for industrial robots on a factory floor or synthesizing gaits for enabling a legged robot to move across an uneven terrain, can reap benefit from learning the underlying latent space dynamics. Such insight will enable implementation of effective control loops with assurances on desired behavior, as well as pave the way for model-based approaches to safe reinforcement learning.

Existing framework to model contact dynamics, such as Neural Physics Engine and Interaction Networks, use relational priors to learn motions of physical systems. However, while these models can handle collisions and contacts, they are not ODE-based and do not enforce the underlying physic-based constraints, such conservation of energy and momentum. Other works have also investigated the problem of learning impulses from contacts and collisions of rigid bodies. However, they primarily focus on only frictionless 2D contacts, and the learning of frictional contacts as well as 3D contact is under explored in the current state-of-the-art. On the other hand, a growing body of literature focuses on enforcing physics-based constraints while learning dynamics for data. For example, Symplectic ODE-Net leverages Hamiltonian dynamics to design neural network architectures. However, these approaches cannot accommodate jump discontinuities and hence are not suitable for a various real-world applications, for example, robotic grippers and legged robots.

Particle flows are very common in a variety of applications in the process and mineral processing industry (e.g., pneumatic/belt conveyors, chutes, cyclones, etc.) for various processing operations. These processes typically involve flow of particles with their dynamics governed by momentum and energy transfer. Therefore, modelling the particulate behavior during the design phase and uncovering various underlying factors from observed data during the operation phase is key to improving such processing operations. Traditional approaches to simulate granular flow/movement of particles include Lagrangian Particle Models and Discrete Element models. There are commercially available software solutions (e.g., Siemens Simcenter Star-CCM+) that use such approaches for modeling particle movements in equipment. However, these approaches are typically not differentiable, and hence render solving the inverse problems (e.g., design optimization, identification of relevant properties/factors from observations of particle flow) computationally very expensive.

### SUMMARY

A proposed framework utilizes differentiable optimization and physics-informed machine learning to learn dynamic models of physical systems with jump discontinuities, such as objects experiencing contacts/collisions (e.g., mobile robots, rigid bodies), as well as inequality constraints. The differentiable framework models and simulates the interaction between rigid bodies, such as individual particles, useful for solving problems related to particulate models (e.g., flow of particulate material in an industrial production and processing system).

A differentiable contact model leverages recent progress on differentiable solvers through convex optimization problems. The problem of solving impacts due to contacts/collisions can be formulated as a convex optimization problem with convex quadratic objectives with linear and second order cone constraints. This enables a disciplined parametrized programming to express problems solved via differentiable layers using CvxpyLayers. With the contact model being differentiable, it is useful for learning parameters. The proposed contact model is integrated into energy conserving neural-networks, such as Hamiltonian and Lagrangian neural networks, to expand the scope of these frameworks for modeling and learning dynamics with velocity jump discontinuities. The proposed solution can capture contact/collision mechanics, both friction-less and frictional, as well as both elastic and inelastic. In addition, it can accommodate inequality constraints.

### BRIEF DESCRIPTION OF THE DRAWINGS

Non-limiting and non-exhaustive embodiments of the present embodiments are described with reference to the following FIGURES, wherein like reference numerals refer to like elements throughout the drawings unless otherwise specified.

FIG. 1 shows an example of a framework for modeling and simulating contact interaction of particles or bodies during dynamic flow or motion in accordance with embodiments of this disclosure.

FIG. 2 illustrates a method for modeling and simulating contact interaction of particles or bodies during dynamic flow or motion in accordance with embodiments of this disclosure.

FIG. 3 illustrates an example of a computing environment within which embodiments of the disclosure may be implemented.

### DETAILED DESCRIPTION

Methods and systems are disclosed to address problems in modeling rigid body motion with contacts/collisions, such as enabling discontinuity of states to be considered. A proposed framework includes a differentiable contact model which leverages differentiable solvers through convex optimization problems. Contact/collision impulses are modeled as a convex optimization formulation with convex quadratic objectives as well as linear and second order cone constraints. Parametrized programming is used to express the optimization problems. The contact model is integrated into energy conserving neural-networks, such as Hamiltonian and Lagrangian networks, to expand the scope the proposed framework for modeling and learning dynamics with jump discontinuities. Unlike conventional models that are based only on ordinary differential equation (ODE) solutions, the proposed differentiable contact model of this disclosure allows the learning of contact properties along with the learning of system properties (e.g., mass of objects and potential energy of the system) of various physical systems. The problem with ODE based solutions is that they serve to learn dynamics of continuous systems (i.e., in which state variables change continuously over time) but cannot accurately represent systems that involve contacts/collisions due to the discontinuous properties of the effects of contacts/collisions in a system.

Recently introduced non-ODE based solutions demonstrate modeling for 2D frictionless contacts. The novel framework of this disclosure captures discontinuities related to contact/collision mechanics, both friction-less and frictional, as well as both elastic and inelastic, and for both 2D and 3D contacts. In addition, the proposed framework accommodates inequality constraints, such as limits on joint angles of a robot. Learned contact properties, such as coefficients of restitution and friction, are interpretable and match ground truths with high accuracy.

As an introduction to the dynamics being modeled in this disclosure, the following description considers a rigid body system with possible holonomic constraints but free of collision and contact. The configuration of the system at time t can be described by a set of coordinates x(t)=(x1(t), x2(t), . . . , xD(t)). Then the time evolution of the rigid body system is governed by the Lagrangian dynamics and can be expressed in terms of location x and velocity v as follows:

$$\ddot{x} = f ( x , \dot{x} ) . \qquad ( 1 )$$

$$( \begin{matrix}\dot{x} \\ \dot{v}\end{matrix} ) = ( \begin{matrix}v \\ f ( x , v )\end{matrix} ) = Ψ ( x , v ) \qquad ( 2 )$$

where (\dot{ }) represents a derivative with respect to time and (\ddot{ }) represents a double derivative with respect to time. In a simulation setting, with a known vector field f and an initial condition of x and \dot{x}, the trajectory of the system can be generated by solving the initial value problem of Eq. (1). In a learning setting, the vector field f itself or some parameters in the functional form f is unknown and the goal is to learn the unknown vector field or parameters from a given set of trajectories.

There are two popular choices of coordinates—the generalized coordinates and the Cartesian coordinates. The generalized coordinates are a set of independent coordinates which implicitly enforces holonomic constraints in the system. The Cartesian coordinates are in general not independent with each other, the holonomic constraints in the system must be enforced explicitly in the dynamics. The proposed differentiable contact impulse solver in this disclosure is independent of the form of dynamics, although it is described along with the constrained Lagrangian dynamics on various systems.

In robotics tasks, the above assumption of no collision and contact no longer holds. For example, legged robots move around through repeated collisions/contacts between the robot legs and the ground, and robot arms grasp objects by making frictional contact with them. The difficulty of modeling these phenomena is that they essentially make the dynamics discontinuous. For example, when a ball hits the ground, its velocity changes from pointing downward to pointing upward in an infinitesimally small period of time, which can be modeled as an instantaneous impulse in velocity. In general, collision, contact and limits in the angle can all be modeled as an impulse in the velocity, as shown in Algorithm 1.

Algorithm 1 Simulation with Contact

```
  Input: initial condition (x₀, v₀), dynamics f(x, v), collision
  detector and contact impulse solver
  Initialize (x, v) = (x₀, v₀), initialize trajectories [symbol]
  for t = 1 to T do
    (xₜ, vₜ) ← ODESolve(f, (x, v), t − 1, t)
    isCld ← CollisionDectector(xₜ)
    if isCld then
      Δv ← ImpulseSolver(xₜ, vₜ)
      vₜ ← vₜ + Δv
    end if [symbol]
    .append((xₜ, vₜ))
    (x, v) ← (xₜ, vₜ)
  end for
  Output: Trajectories [symbol]
```

From a learning perspective, if the physical properties of the contacts (e.g., the friction coefficient and the elasticity) are unknown and a set of training trajectories is available, the unknown physical properties are parameterized by learnable parameters. The difference between the predicted and true trajectories are minimized, the parameters are learned by back propagation through an ODE solver and a contact impulse solver. A neural ODE solver can provide a framework of back propagating through ODE solvers with constant memory usage and it can be leveraged by Symplectic ODE-Net and Constrained Lagrangian/Hamiltonian Neural Network (CLNN/CHNN) to learn unknown physical properties in rigid body dynamics without contacts. In embodiments of this disclosure, a contact impulse solver is configured to be differentiable so that rigid body dynamics can be learned with contact/collision.

In vector calculus, the Jacobian matrix (or simply “Jacobian”) of a vector-valued function of several variables is the matrix of all its first-order partial derivatives. The Jacobian represents the differential of a function at every point where it is differentiable. Holonomic constraints are equality constraints which can be collected into a column vector Φ(x)∈ [symbol] ^{K} with expression Φ(x)=0, and defined by the following expression:

\dot{Φ}=(∇ₓΦ)\dot{x}=(∇ₓΦ)v=J_{E}(x)·v=0 (3)

where the equality constraint Jacobian J_{E}(x):=∇ₓΦ∈ [symbol] ^{K×D}, with ∇ₓΦ representing the gradient of vector Φ. According to Eqn. (3), the holonomic constraints require the velocity v to be always in the null space of equality constraint Jacobian J_{E}(x).

In contrast with the equality constraint above, modeling contacts is formulated according to an inequality for the column vector, which can be expressed by the following:

Φ_{C}(x)≥0 (3a)

For example, when modeling a ball bouncing on the ground, the contact state is defined as inactive while any point in the ball is in a vertical position above the ground, i.e., Φ_{C}(x)>0, where the ground is defined at position value of zero (0). Once the ball makes contact with the ground, an active contact state is defined by Φ_{C}(x)=0, as at least one point of the ball is located at the position value zero (0). According to embodiments of this disclosure, a collision detection module, described below in greater detail, detects whether a contact is active or inactive using the relative inequality principle of Eq. (3a). Active contacts cause a velocity impulse, which are determined by a contact impulse solver of the disclosed differentiable framework. From the velocity impulse estimation, trajectories for the colliding bodies can then be estimated by the disclosed differentiable framework.

A conceptual contact can contribute to one or more dimensions in the contact space, corresponding to one or more dimensions of contact force. A ball bouncing on a frictional ground, for example, will experience a contact force f=(f₁, f₂, f₃) in the three-dimensional contact space, where f₁ is the component normal to the contact surface, and f₂ and f₃ are two tangential frictional components. Assuming a C dimensional contact space with dimension D for vector x, contact Jacobian J_{C} is defined as J_{C}(x)∈ [symbol] ^{C×D}, such that the velocity in the contact space v_{C}=J_{C}(x)·v.

The elasticity of a collision can be captured by the coefficient of restitution. According to Newton's hypothesis, the coefficient of restitution (COR) is defined as the ratio of the normal relative velocity after the collision to that before the collision, ranging from 0 to 1. This definition of COR can cause an unrealistic energy increase when the contact is frictional and the COR is close to a value of 1. Alternatively, Poisson hypothesis divides the collision into two phases. The first, referred to as the compression phase, start with the first contact of the bodies and stops at the greatest compression. The second, referred to as the restitution phase, starts after the compression phase and concludes with the separation of compressed bodies. According to Poisson's hypothesis, the COR is defined as the ratio of the normal contact impulse in the restitution phase to that in the compression phase. Poisson's hypothesis is favored in simulation since it will not lead to unrealistic energy increase. In this disclosure, we define COR e in accordance with Poisson's hypothesis.

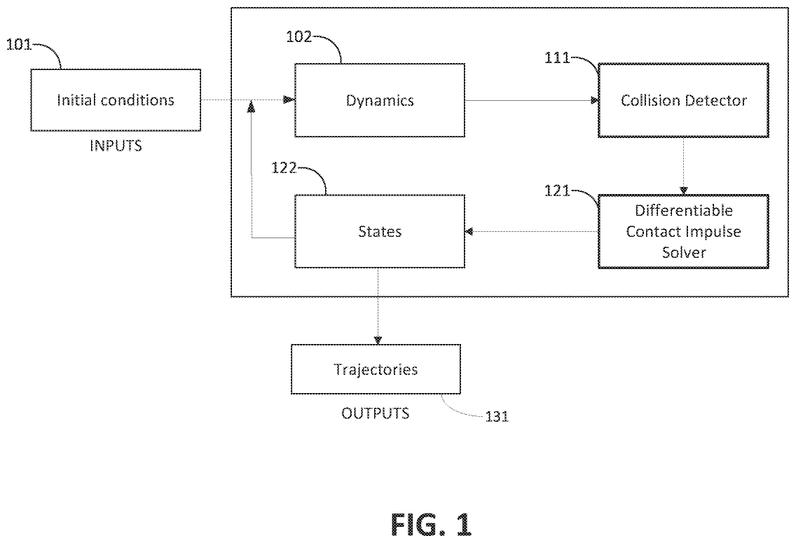

FIG. 1 shows an example of a framework for modeling and simulating contact interaction of particles or bodies during dynamic flow or motion in accordance with embodiments of this disclosure. In an embodiment, the proposed framework includes a dynamics solver 102, collision detector 111 and a differentiable contact impulse solver 121. Inputs to dynamics solver 102 include initial conditions 101 (e.g., initial position x₀, initial velocity v₀, and initial trajectories T₀), and dynamics data 102 (e.g., f(x,v)). For simplicity herein, a method is described with reference to x and v as position and velocity in Cartesian space, but the derivation is valid for any other choice of coordinate system. Dynamics solver 102 models and simulates the motion of rigid bodies for a given dynamic system. In an aspect, neural networks may be used to implement models for the rigid bodies.

The differentiable contact impulse solver 121 is configured to project velocity jumps in contact space. In an embodiment, collision detector 111 monitors a time series of variables (x,v) as modeled by dynamics solver 102 and detects collisions based on the active contact determination in accordance with relative position inequality (Eq. (3a)). If the collision detection module 111 detects active contacts, the differentiable contact impulse solver 121 constructs Jacobian J_{C} and formulates the velocity jump during compression phase and restitution phase described by the following equation:

Mv⁺=Mv⁻+J_{C}^{T}f_{C}+J_{E}^{T}f_{E}. (4)

where v− and v+ denote the Cartesian space velocity before and after the jump, M is the inertia matrix, J_{C}^{T} maps force impulses in the contact space f_{C} to force impulses in the Cartesian space, and similar reasoning applies to equality constraint Jacobian J_{E}^{T}. However, the two impulses are not independent as the velocity in the Cartesian space at any time is in the null space of J_{E} because of equality constraints. Rearranging Eq. (4) with multiplication of J_{E}M⁻¹ yields:

f_{E}=−(J_{E}M⁻¹J_{E}^{T})⁻¹J_{E}M⁻¹J_{C}^{T}f_{C} (5)

v⁺=v⁻+\hat{M}⁻¹J_{C}^{T}f_{C}. (6)

where

\hat{M}⁻¹=M⁻¹−M⁻¹J_{E}^{T}(J_{E}M⁻¹J_{E}^{T})⁻¹J_{E}M⁻¹ (7)

The term \hat{M} can be interpreted as the inertia that incorporates equality constraints. Projecting Cartesian velocity into the contact space gives the following expression:

v_{C}⁺=v_{C}⁻+Af_{C}, (8)

where

A=J_{C}\hat{M}⁻¹J_{C}^{T}, (8a)

which can be interpreted as the inverse inertia in the contact space. The velocity jump in the contact space can be expressed as follows for Eq. (9) and Eq. (10) for compression phase and restitution phase respectively:

v_{C}^{c+}=v_{C}^{c-}+Af_{C}^{c}, (9)

v_{C}^{r+}=v_{C}^{c+}−v_{C}*+Af_{C}^{r}. (10)

where v_{C}* is a target velocity used to compensate existing penetration in the simulation.

In an embodiment, the differentiable contact impulse solver 121 applies constraints on contact forces based on a frictional contact, such as rigid bodies colliding in free space. For any conceptual frictional contact i in 3D contact space, the contact force fᵢ∈ [symbol] ³ must lie in the friction cone, and the normal forces must be non-negative, since objects can only push but not pull others. This yields the following formulations for defining the contact force:

μᵢf_{i,1}≥\sqrt{f_{i,2}²+f_{i,3}²} (11)

f_{i,1}≥0 (12)

where μᵢ represents a learnable parameter for coefficient of friction (COF). In another embodiment, where the bodies in motion relate to limit in joint angle or distance, such as in a pendulum motion, the contact space is essentially one dimensional and the constraints on contact forces can be represented by the Eq. (12), which is equivalent to defining a 3D contact space like that in frictional contact and letting the COF parameter μᵢ=0 in Eq. (11).

In an embodiment, the differentiable contact impulse solver 121 generates a contact model in compression phase based on maximum dissipation principle, which states that the compression impulses should maximize the rate of energy dissipation. Equivalently, the compression impulses are those that minimize the kinetic energy at the end of the compression phase. This yields the following expression of optimization formulation:

$${Minimize}_{f} \text{?} \frac{1}{2} {( {v}_{C}^{c +} )}^{T} {A}^{- 1} {v}_{C}^{c +} subject to ( 11 ) , ( 12 ) \\ \text{?} \text{indicates text missing or illegible when filed} \qquad ( 13 )$$

The optimization formulation (13) can be reformulated by substituting Eq. (9) into the objective, which yields the following equivalent optimization formulation (14), from which we can solve for contact force in compression phase f_{C}^{c}.

$${Minimize}_{f} \text{?} \frac{1}{2} {( {f}_{C}^{c} )}^{T} {Af}_{C}^{c} + {( {f}_{C}^{c} )}^{T} {v}_{C}^{c -} subject to ( 11 ) , ( 12 ) \\ \text{?} \text{indicates text missing or illegible when filed} \qquad ( 14 )$$

In an embodiment, the differentiable contact impulse solver 121 is configured to generate a contact model in restitution phase in which an optimization problem is derived to solve for the contact force in restitution phase f_{C}^{r}. According to Poisson's hypothesis, the normal components in restitution phase contact force f_{C}^{r} are those in compression phase contact force f_{C}^{c} scaled by coefficient of restitution COR e. This yields the following constraint:

f_{i,1}^{r}≥eᵢf_{i,1}^{c} (15)

This constraint of the contact model in restitution phase is useful to compensate for penetration of colliding bodies or particles in the simulation as the rigid body system is simulated in discrete time steps.

By setting up the restitution phase constraint according to Eq. (15), a greater normal impulse is allowed when COR is small and penetration is deep. When COR is large and penetration is shallow, the equality holds for the solution respecting Poisson's hypothesis due to the principle of maximum dissipation. Thus, using the velocity jump v_{C}^{r+} according to Eq. (10) and the restitution constraint according to Eq. (15), penetration compensation and Poisson's hypothesis are taken into account, which sets up the following optimization formulation from the principle of maximum dissipation to solve for restitution contact force f_{C}^{r}:

$${Minimize}_{{f}_{C}^{r}} \frac{1}{2} {( {f}_{C}^{r} )}^{T} {Af}_{C}^{r} + {( {f}_{C}^{r} )}^{T} ( {v}_{C}^{c +} - {v}_{C}^{*} ) \\ subject to ( 11 ) , ( 12 ) , ( 15 ) \qquad ( 16 )$$

Using optimization criteria (14) and (16), the differentiable contact impulse solver 121 solves for contact forces and calculates velocity impulses to perform trajectory simulation with realistic dynamic interactions that account for contacts/collisions according to Algorithm 1. With reference to FIG. 1, a time series of dynamic system states 122 are determined by contact impulse solver 121 by applying contact forces and velocity impulses to rigid body positions, and trajectories 131 are estimated from the time series data. Moreover, backpropagating through the dynamics solver 102 and the differentiable contact impulse solver 121 accomplishes end-to-end learning of COF and COR parameters. For example, in a learning phase for the framework 100, known trajectories are compared against estimated trajectories 131 and iterative operations with backpropagation are performed to yield optimized parameters for the dynamic modeling and simulation.

In an embodiment, optimization formulations (14) and (16) are convex optimization problems with convex quadratic objectives as well as linear and second order cone constraints, which makes contact impulse solver 121 differentiable. In an aspect, inverse inertia matrix A of Eq. (8) and optimization formulations (14) and (16) is positive semi-definite. This enables statement of dynamic system problems using disciplined parametrized programming, where the optimizations can be set up as differentiable layers in the contact impulse solver 121. For example, the module for optimization formulations (14) and (16) may be generated using a software tool such as Cvxpy-Layers.

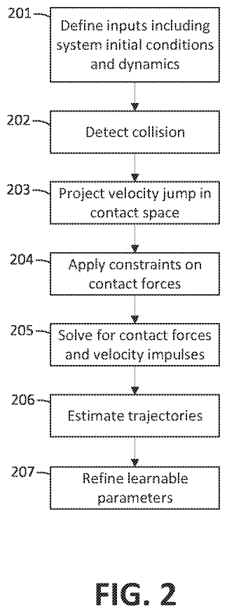

FIG. 2 illustrates a method for modeling and simulating contact interaction of particles or bodies during dynamic flow in accordance with embodiments of this disclosure. Method 200 begins with defining inputs for the model, including system initial conditions (step 201). The differentiable dynamics solver 102 starts the simulation of dynamic particles or bodies and collision detector 111 detects instances of active contacts (step 202). Differentiable contact impulse solver 121 projects velocity jump in contact space (step 203), which models velocity jump in compression and restitution phases according to Eq. (8) and Eq. (9). Constraints for contact forces (e.g., frictional contact force, limit in joint angle or distance) are applied according to Eq. (11), (12) and (15) (step 204). Using the applied constraints, contact impulse solver 121 solves for contact forces and velocity impulses for compression phase and restitution phase while optimizing for maximum dissipation according to optimization formulations (14) and (16) (step 205). Trajectories of rigid bodies reacting to collision are estimated based on the contact forces and velocity impulses (step 206). Backpropagation through the contact impulse solver 121 is performed for refining learnable COF and COR parameters (step 207). In an embodiment, the method 200 employs the framework 100 to model and simulate contact interaction of particulate matter of a material processing system (e.g., involving flow of particulate material while on a conveyor or other transference mechanism). In another embodiment, the method 200 employs the framework 100 to model and simulate interaction of collision between a robot and objects, useful for controlling drivers of robotic joints. In any such modeled systems, the initial conditions and dynamics may be defined for frictional or frictionless contact, elastic or inelastic contacts, and for 2D or 3D contacts.

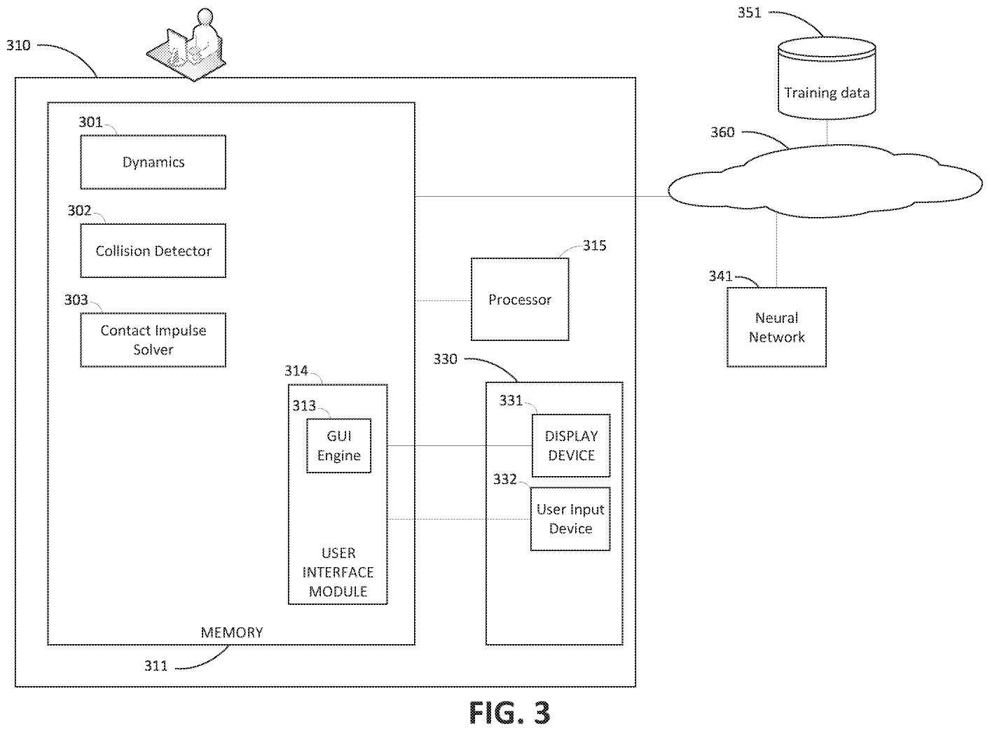

FIG. 3 shows an example of a computer environment within which embodiments of the disclosure may be implemented. A computing device 310 includes a processor 315 and memory 311 (e.g., a non-transitory computer readable media) on which is stored various computer applications, modules or executable programs. In an embodiment, computing device includes one or more of the following modules: a dynamics module 301, a collision detector module 302, a differentiable contact impulse solver module 303, which execute functionality of respective components of framework 100: dynamics solver 102, collision detector 111, and differentiable contact impulse solver 121, shown in FIG. 1.

As shown in FIG. 3, a cloud based neural network (NN) 341 may be implemented for modeling the dynamic system by dynamics module 301 and/or learning parameters for the contact impulse solver module 303. The NN 341 incorporates physics priors of Lagrangian dynamics to learn physical motions with less data and better generalization. Examples of neural networks that may be implemented include but are not limited to Lagrangian NN (LNN), Hamiltonian NN (HNN), Symplectic Recurrent NN (SRNN), and Symplectic ODE-Net.

A network 360, such as a local area network (LAN), wide area network (WAN), or an internet based network, connects training data 351 to NN 341 and to modules 301, 302, 303 of computing device 310.

User interface module 314 provides an interface between modules 301, 302 and user interface 330 devices, such as display device 331 and user input device 332. GUI engine 313 drives the display of an interactive user interface on display device 331, allowing a user to receive visualizations of analysis results and assisting user entry of learning objectives and domain constraints for modules 301, 302, 303, and 341.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The program modules, applications, computer-executable instructions, code, or the like depicted in FIG. 3 as being stored in the system memory 311 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 310, and/or hosted on other computing device(s) accessible via one or more of the network(s) 360, may be provided to support functionality provided by the program modules, applications, or computer-executable code and/or additional or alternate functionality. Further, functionality may be modularized differently such that processing described as being supported collectively by the collection of program modules depicted in FIG. 3 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 3 may be implemented, at least partially, in hardware and/or firmware across any number of devices.

It should further be appreciated that the computer system 310 may include alternate and/or additional hardware, software, or firmware components beyond those described or depicted without departing from the scope of the disclosure. More particularly, it should be appreciated that software, firmware, or hardware components depicted as forming part of the computer system 310 are merely illustrative and that some components may not be present or additional components may be provided in various embodiments. While various illustrative program modules have been depicted and described as software modules stored in system memory 311, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A system for modeling motion and collision of rigid bodies in a dynamic system, comprising:
a processor; and
a non-transitory memory having stored thereon modules executed by the processor, the modules comprising:
a collision detector configured to learn active contacts of the rigid bodies; and
a differentiable contact impulse solver configured to apply constraints on contact forces related to a compression phase, apply coefficient of restitution on contact forces related to a restitution phase, solve for contact forces and velocity impulses associated with the active contacts in the compression phase and the restitution phase, and estimate trajectories of the rigid bodies based on the contact forces and velocity impulses, wherein the solving is optimized for maximum rate of energy dissipation.

2. The system of claim 1, wherein the rigid bodies relate to particulate material transported by a conveyor system.

3. The system of claim 1, wherein the modules further comprise a neural network module configured to learn physical motions of the objects incorporating physics priors.

4. The system of claim 1, wherein the differentiable contact impulse solver is further configured to perform backpropagation during simulation to perform learning of parameters.

5. The system of claim 4, wherein the parameters include at least one of coefficient of friction and coefficient of restitution.

6. The system of claim 1, wherein differentiable contact impulse solver is further configured to determine inverse inertia in contact space.

7. The system of claim 5, wherein the inverse inertia is positive semi-definite.

8. A computer based method for modeling motion and collision of rigid bodies in a dynamic system, comprising:
detecting, by a collision detector module, active contacts of the rigid bodies;
applying constraints on contact forces related to a compression phase;
applying coefficient of restitution on contact forces related to a restitution phase;
solving for contact forces and velocity impulses associated with the active contacts in the compression phase and the restitution phase; and
estimating trajectories of the rigid bodies based on the contact forces and velocity impulses, wherein the solving is optimized for maximum rate of energy dissipation.

9. The method of claim 8, wherein the rigid bodies relate to particulate material transported by a conveyor system.

10. The method of claim 8, further comprising:
learning, by a neural network module, physical motions of the objects incorporating physics priors.

11. The method of claim 8, further comprising:
performing, by the differentiable contact impulse solver module, backpropagation during simulation to perform learning of parameters of the dynamic system.

12. The method of claim 11, wherein the learning tasks include learning contact properties including at least one of coefficient of friction and coefficient of restitution.

13. The method of claim 8, further comprising:
determining, by the differentiable contact impulse solver, inverse inertia in contact space.

14. The method of claim 13, wherein the inverse inertia is positive semi-definite.
